(19) United States
(12) Patent Application Publication
(10) Pub. No.: US 2018/0224114 A1
(43) Pub. Date: Aug. 9, 2018

(54) MULTI-FUNCTIONAL AUDIO LIGHTS

(71) Applicant: Aixia Bian, Shanghai (CN)

(72) Inventor: Aixia Bian, Shanghai (CN)

(21) Appl. No.: 15/475,644

(22) Filed: Mar. 31, 2017

Related U.S. Application Data
(60) Provisional application No. 62/456,538, filed on Feb. 8, 2017.

(51) Int. Cl. F21V 33/00; F21V 21/30; F21V 23/04; F21L 4/08; F21V 21/14; F21V 21/096; H04R 1/02

(52) U.S. Cl. CPC F21V 33/0056; F21V 21/30; F21V 23/0414; F21L 4/08; F21Y 2115/10; F21V 21/0965; F21V 23/0435; H04R 1/028; H04R 1/026; F21V 21/145

(57) ABSTRACT

This present invention provides an audio light comprising a housing; a light source affixed to a surface of the housing and operable to emit light; one or more speakers disposed in the housing and operable to emit sound; and a power source operable to power the light source and the one or more speakers.

### CROSS-REFERENCE TO RELATED APPLICATION

The present application claims priority to U.S. Application No. 62/456,538, filed on Feb. 8, 2017, the contents of which are incorporated herein by reference in their entirety.

### BACKGROUND OF THE INVENTION

Advances in technology have enabled lighting devices to become increasingly lightweight and portable. Light emitting diodes (LEDs) are capable of efficiently converting electrical energy into light with little waste heat, allowing them to provide extended illumination with portable energy sources, such as batteries. Likewise, advances in audio technology have led to the creation of lightweight, portable speakers that can be controlled wirelessly.

In some applications, it would be desirable to utilize portable lighting technology and portable audio technology at the same time. However, a portable device that combines both functionalities does not currently exist in the art. Thus, there is an identifiable need for a portable device that combines both audio and lighting functionality.

### BRIEF DESCRIPTION OF THE DRAWINGS

FIG. 1 is a rear view of a first example audio light of the present invention.

FIG. 2 is a bottom view of the first example audio light of FIG. 1.

FIG. 3 is a front view of the first example audio light of FIG. 1.

FIG. 4 is a front perspective view of the first example audio light of FIG. 1.

FIG. 5 is a rear perspective view of the first example audio light of FIG. 1.

FIG. 6 is another front perspective view of the first example audio light of FIG. 1.

FIG. 7 is a perspective view of the first example audio light of FIG. 1 connected to an example bar.

FIG. 8 is an enlarged perspective view of the first example audio light of FIG. 1 disconnected from the example bar.

FIG. 9 is a left side view of the first example audio light of FIG. 1.

FIG. 10 is a right side view of the first example audio light of FIG. 1.

FIG. 11 is a top view of the first example audio light of FIG. 1.

FIG. 12 is a rear view of a second example audio light of the present invention.

FIG. 13 is a bottom view of the second example audio light of FIG. 12.

FIG. 14 is a front view of the second example audio light of FIG. 12.

FIG. 15 is a front perspective view of the second example audio light of FIG. 12.

FIG. 16 is a rear perspective view of the second example audio light of FIG. 12.

FIG. 17 is another front perspective view of the second example audio light of FIG. 12.

FIG. 18 is another rear perspective view of the second example audio light of FIG. 12 connected to an example cable.

FIG. 19 is a left side view of the second example audio light of FIG. 12.

FIG. 20 is a right side view of the second example audio light of FIG. 12.

FIG. 21 is a top view of the second example audio light of FIG. 12.

FIG. 22 is a rear view of a third example audio light of the present invention.

FIG. 23 is a bottom view of the third example audio light of FIG. 22.

FIG. 24 is a front view of the third example audio light of FIG. 22.

FIG. 25 is a front perspective view of the third example audio light of FIG. 22.

FIG. 26 is another front perspective view of the third example audio light of FIG. 22.

FIG. 27 is a rear perspective view of the third example audio light of FIG. 22 connected to an example cable.

FIG. 28 is a left side view of the third example audio light of FIG. 22.

FIG. 29 is a right side view of the third example audio light of FIG. 22.

FIG. 30 is a top view of the third example audio light of FIG. 22.

### DETAILED DESCRIPTION OF THE INVENTION

The following description of example methods and apparatus is not intended to limit the scope of the description to the precise form or forms detailed herein. Instead it is intended to be illustrative so that others may follow its teachings.

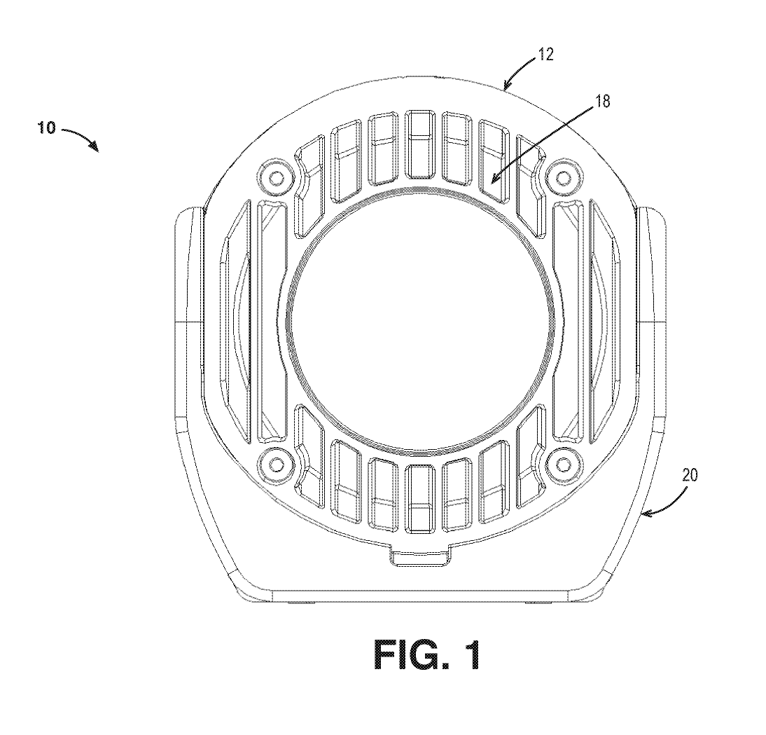

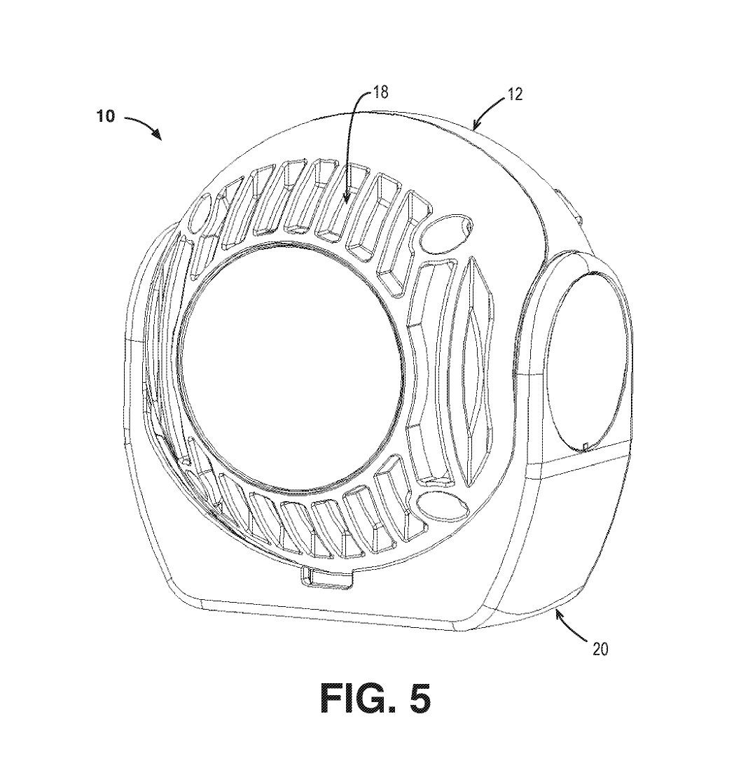

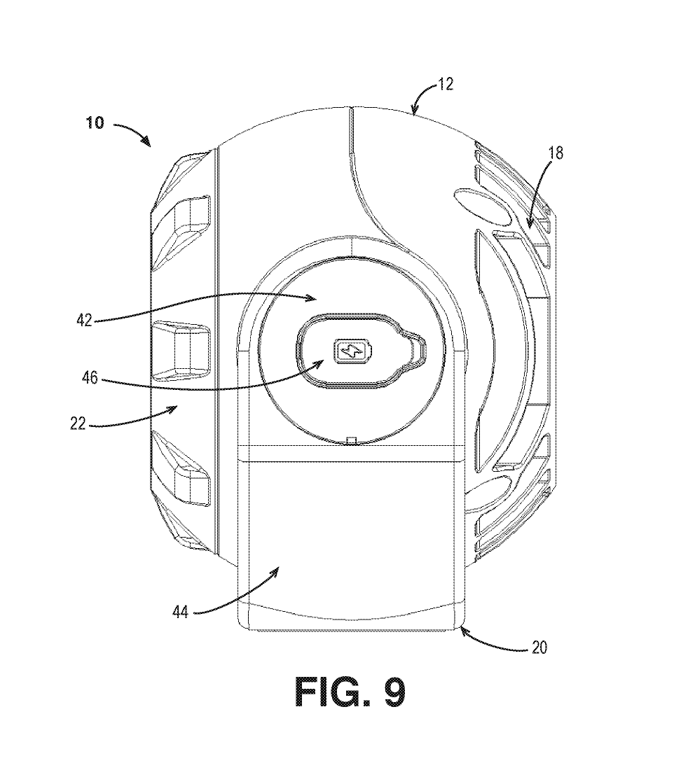

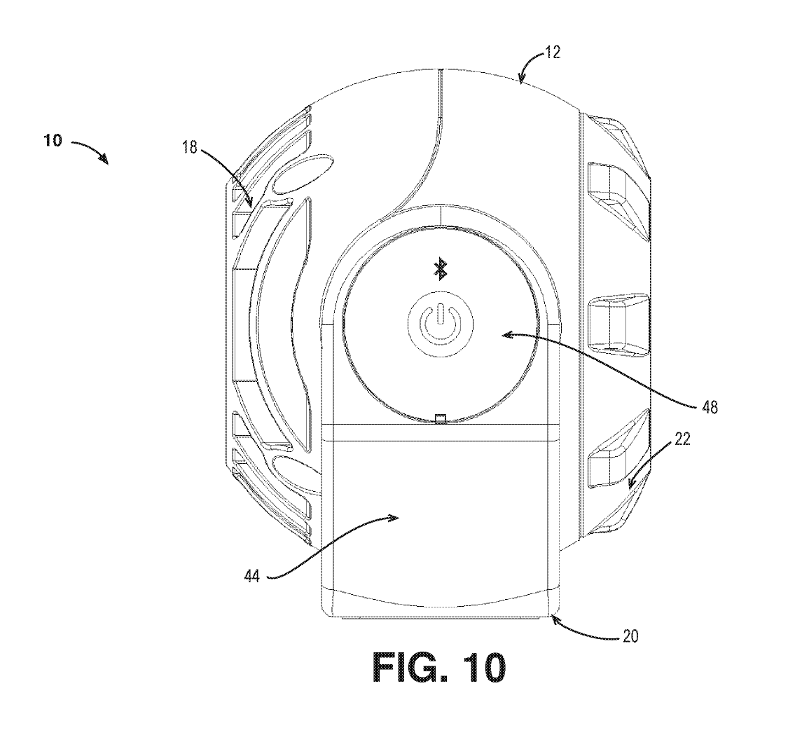

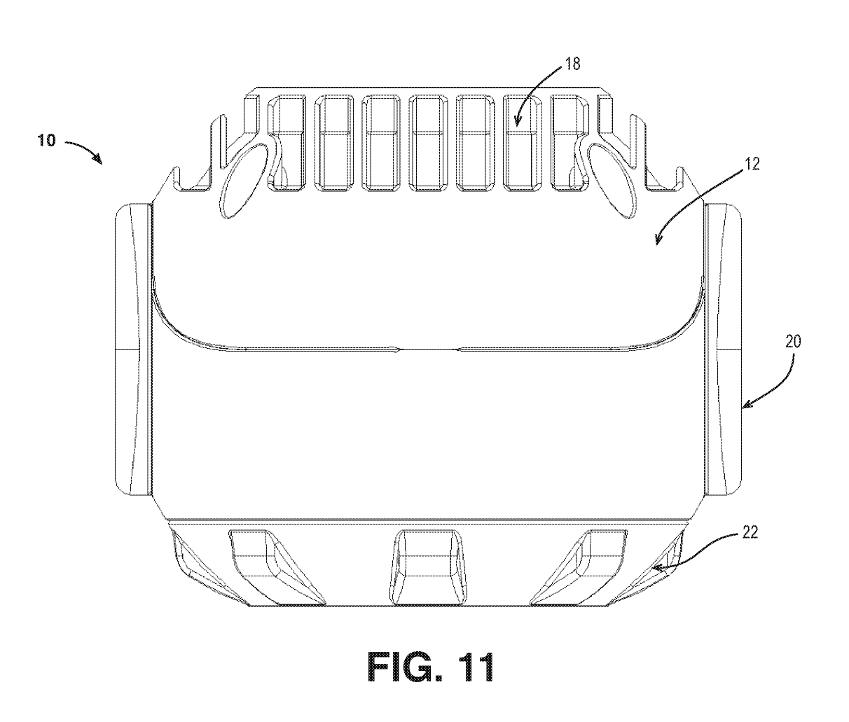

Referring now to FIGS. 1-11, there is illustrated a first example audio light 10 in accordance with the teachings of the present disclosure. The example audio light 10 comprises a housing 12, a lighting unit 16 received in an opening 14 of the housing 12, a speaker 18 disposed in the housing 12, and a bracket 20 connected to the housing 12.

The example audio light 10 may be configured for both indoor and outdoor uses. Thus, the housing 12 may be formed to provide the audio light 10 with impact resistance, water resistance, and/or dust resistance. In the example shown in FIGS. 1-11, the housing 12 is formed with high quality aluminum. However, as will be appreciated by one of ordinary skill in the art, the example housing 12 may be formed with any suitable material, such as for instance, plastic, carbon fiber, etc. The housing 12 may also be provided with a bumper 22 for increased impact resistance.

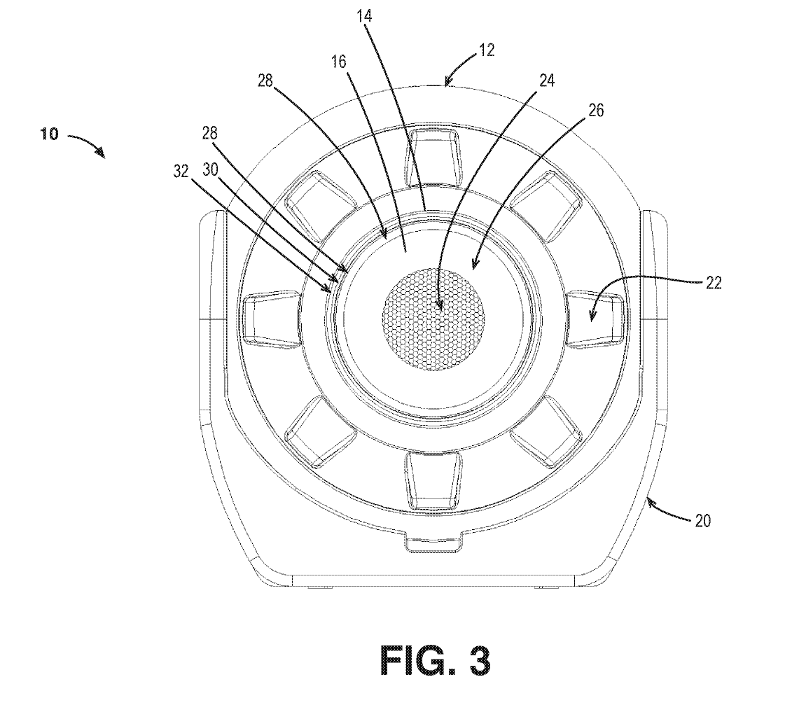

Referring to FIGS. 3-4 and 6-8, the lighting unit 16 includes a light source 24. The light source 24 may comprise one or more LEDs, incandescent bulbs, fluorescent bulbs, halogen bulbs, or the like. In the illustrated embodiment, the light source 24 comprises a high-efficiency, high color rendition index chip-on-board LED. The lighting unit 16 may also include a lens 26 positioned over the light source 24. The lighting unit 16 may further include a reflecting unit 28, so that the audio light 10 can be easily found in the dark. The reflecting unit 28 comprises a reflector 30 and a fluorescer 32. The lighting unit 16 may also include a dimmer (not shown) for adjusting the brightness of the light source 24.

The audio light 10 may additionally include a controller (not shown) disposed in the housing 12. The controller is operably connected to a transceiver (not shown). The controller is configured to receive control signals wirelessly at its transceiver from an external wireless device (not shown), such as a cellular phone, laptop computer, tablet computer, or the like, using radio frequency (RF) transmission. This can be a dedicated RF link, or it can be a wireless network conforming to the international standards such as the Wi-Fi, Bluetooth, or Ultra-Wide-Band (UWB) standards. Other wireless technologies not mentioned above, such as ultra-sound or optical, may also be applicable in this case. Control signals may include, for example, signals for turning on and off or dimming the light source 24, signals for controlling the volume of the speaker 18, signals for playing music through the speaker 18, and the like.

In one embodiment of the present disclosure, the controller is operably connected to the lighting unit 16 and the speaker 18, such that the controller can perform control of the lighting unit 16 and the speaker 18 in response to a control signal received from the external wireless device. For instance, if the controller receives a signal to dim the light source 24, the controller will cause the light source 24 to dim. In another embodiment of the present disclosure, the controller is operably connected to a light source driver (not shown) and a speaker driver (not shown). The light source driver and the speaker driver are configured to perform control of the light source 24 and the speaker 18, respectively. When the controller receives a control signal from the external wireless device, the controller forwards the control signal to the light source driver or the speaker driver. For instance, if the controller receives a signal to dim the light source 24, the controller will forward the signal to the light source driver, and the light source driver will cause the light source 24 to dim.

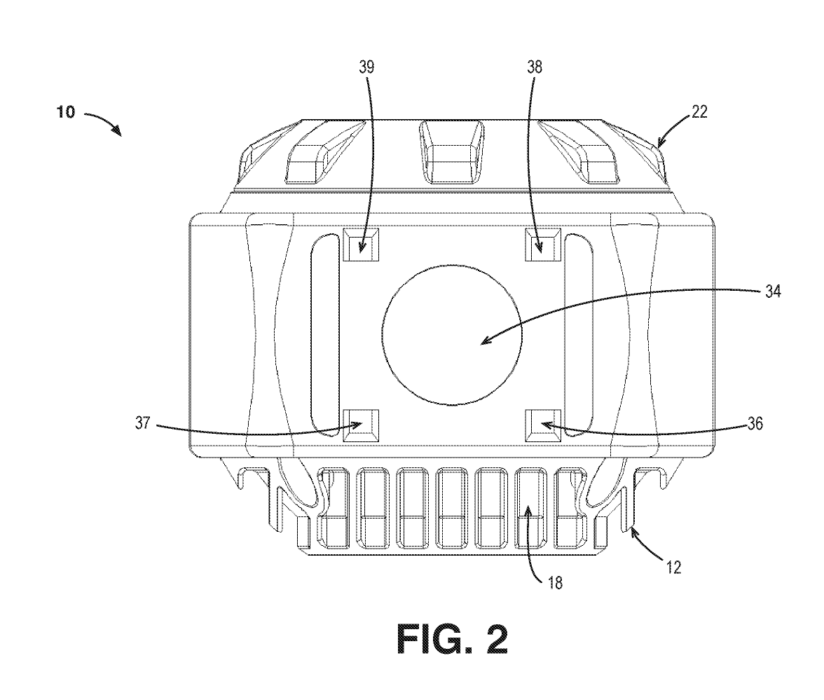

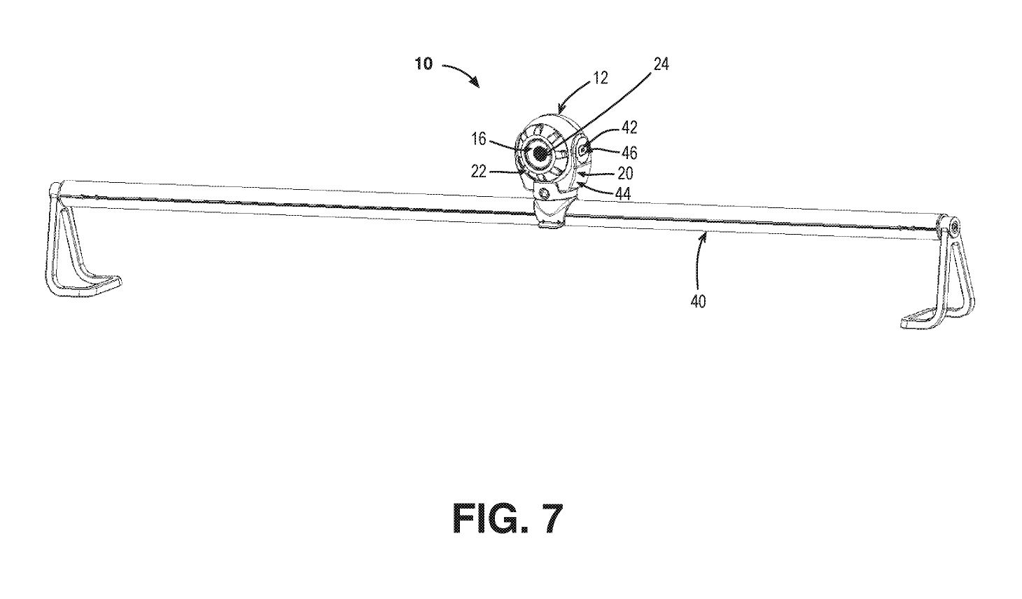

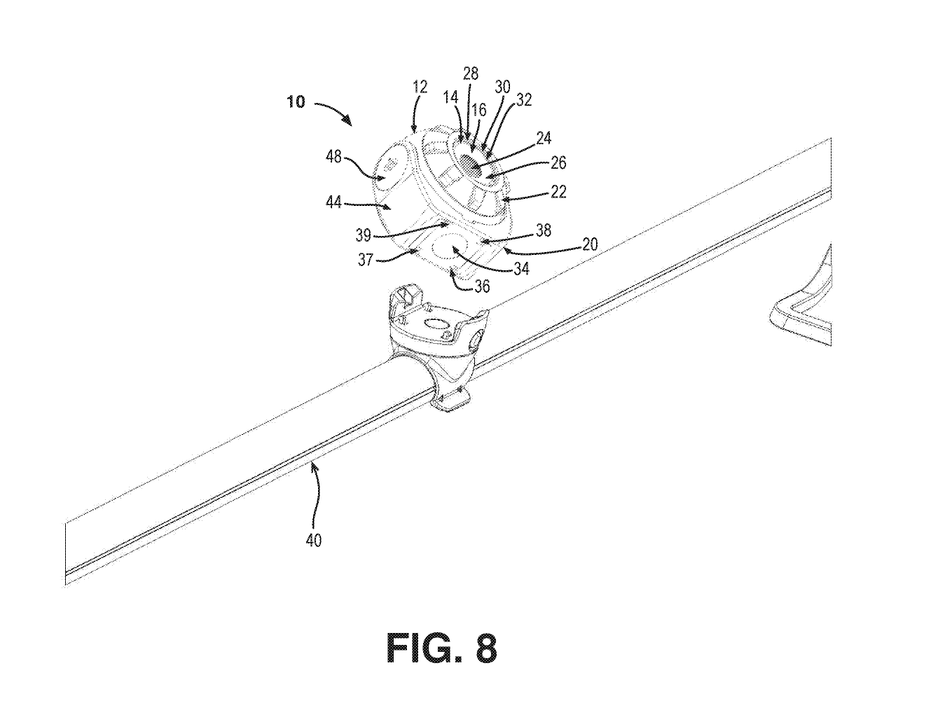

In this disclosure, the bracket 20 of the audio light 10 is pivotally connected to the housing 12 so that the housing 12 may rotate with respect to the bracket 20. It will be appreciated, however, that the bracket 20 need not be pivotally connected to the housing 12, but rather may be connected to the housing 12 in any suitable manner. As shown in FIGS. 2 and 8, the bracket 20 may include a magnet 34, so as to allow the bracket 20 to be magnetically coupled to a metal surface, such as the hood of a car. It will be understood that the size, number, and/or location of the magnet 34 may vary as necessary or desired. The bracket 20 may also include a plurality of holes 36, 37, 38, 39 for connecting the bracket 20 to a stand or support surface, such as a bar 40 as illustrated in FIGS. 7 and 8. It will be understood that the size, number, and/or location of the holes 36, 37, 38, 39 may vary as necessary or desired.

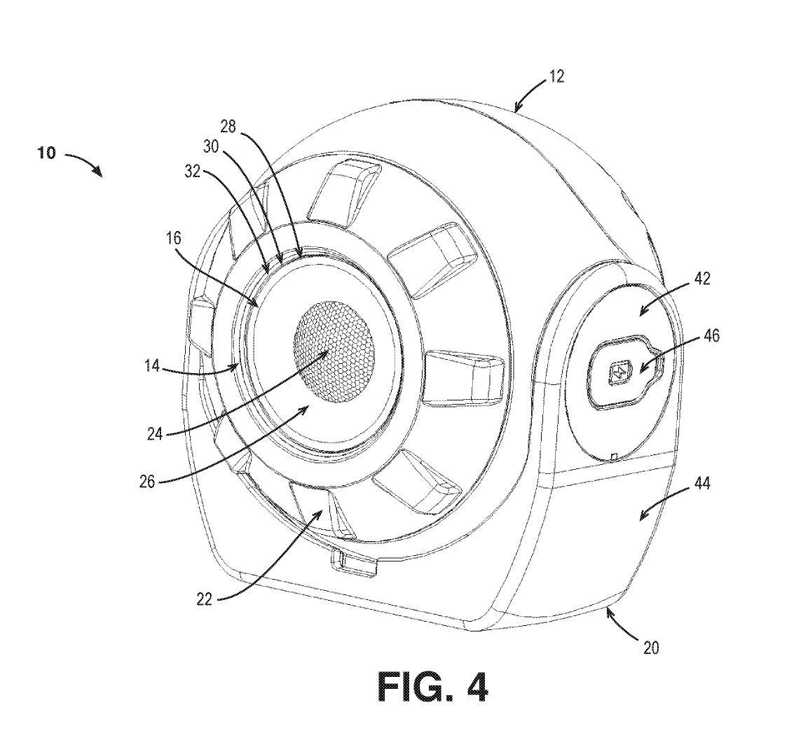

The audio light 10 may also include an internal power supply (not shown), such as a rechargeable lithium-ion battery, so that the audio light 10 may be operated even when disconnected from an external power source (not shown), such as a standard electrical outlet. As shown in FIGS. 4, 7, and 9, to facilitate charging of the internal power supply, an external charging socket 42 may be provided on an exterior surface 44 of the bracket 20. It will be understood that the location of the external charging socket 42 may vary as necessary or desired. The external charging socket 42 may include a protection cap 46 for protecting the external charging socket 42 from damage. The external charging socket 42 is configured to receive a first end of a cable (not shown). The cable may be any type of cable suitable for transferring an electrical signal, such as a Universal Serial Bus (USB) cable or the like. The cable may be selectively connected to the external power source at a second end of the cable.

In one mode of operation, when the first end of the cable is connected to the external charging socket 42, and the second end of the cable is connected to the external power source, the internal power supply is charged by the external power source. When the internal power supply is charged, the cable may be disconnected from the external charging socket 42, and the audio light 10 may be operated without being connected to the external power source by drawing power from the internal power supply. In an alternate mode of operation, when the first end of the cable is connected to the external charging socket 42 and the second end of the cable is connected to the external power source, the audio light 10 is powered directly by the external power source.

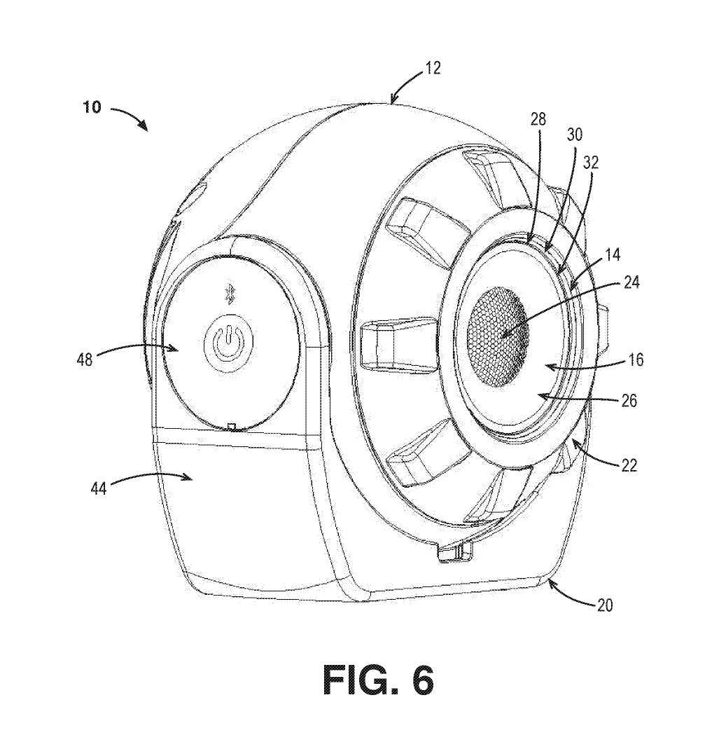

With reference to FIGS. 6, 8, and 10, the audio light 10 may additionally include a power button 48 positioned on the exterior surface 44 of the bracket 20 for turning on and turning off the audio light 10. It will be understood that the location of the power button 48 may vary as necessary or desired.

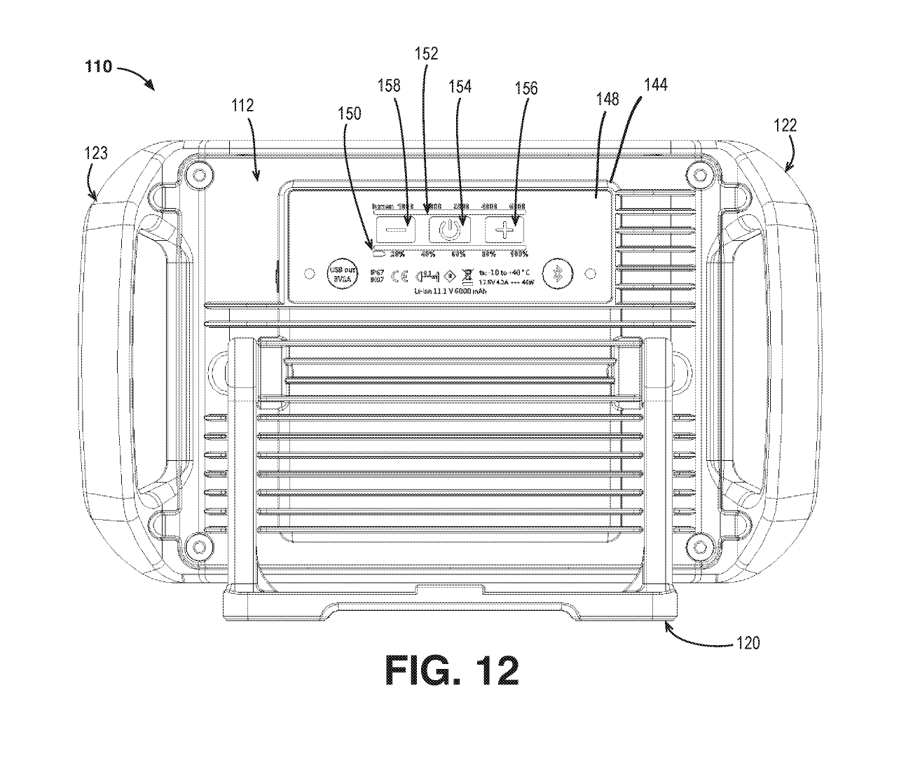

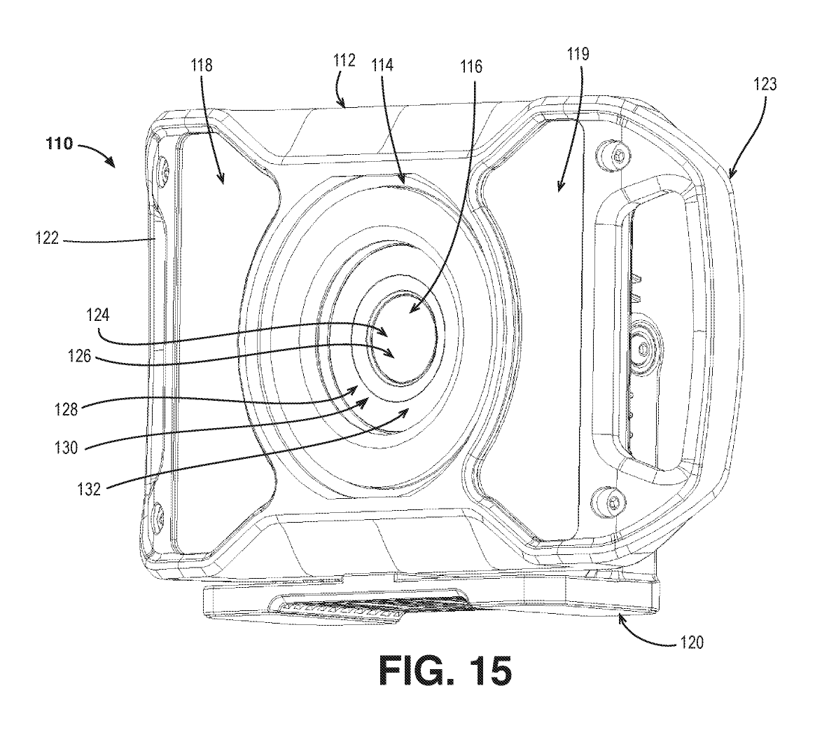

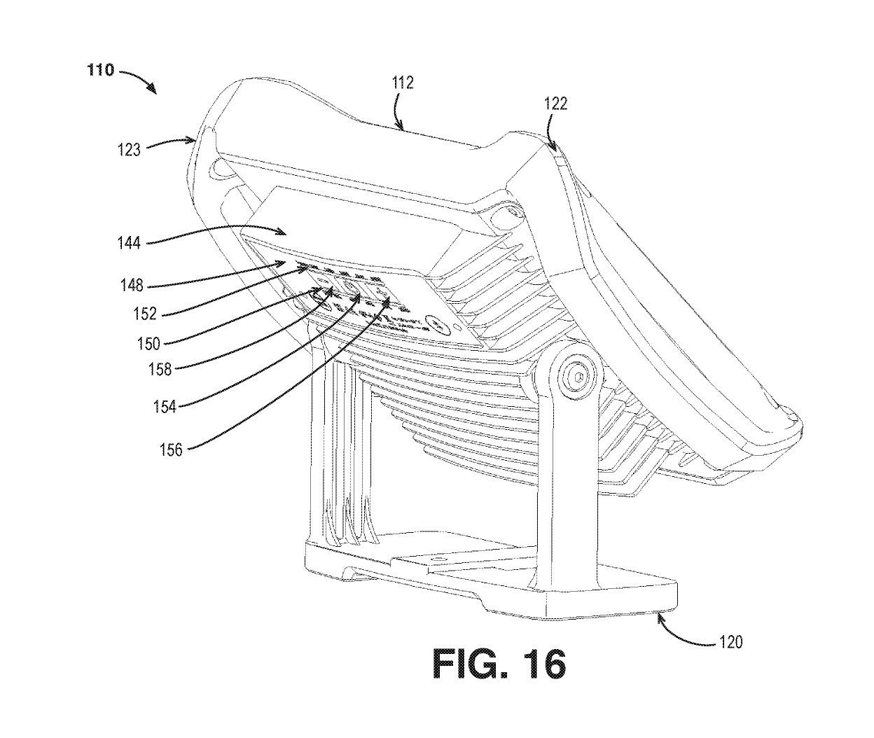

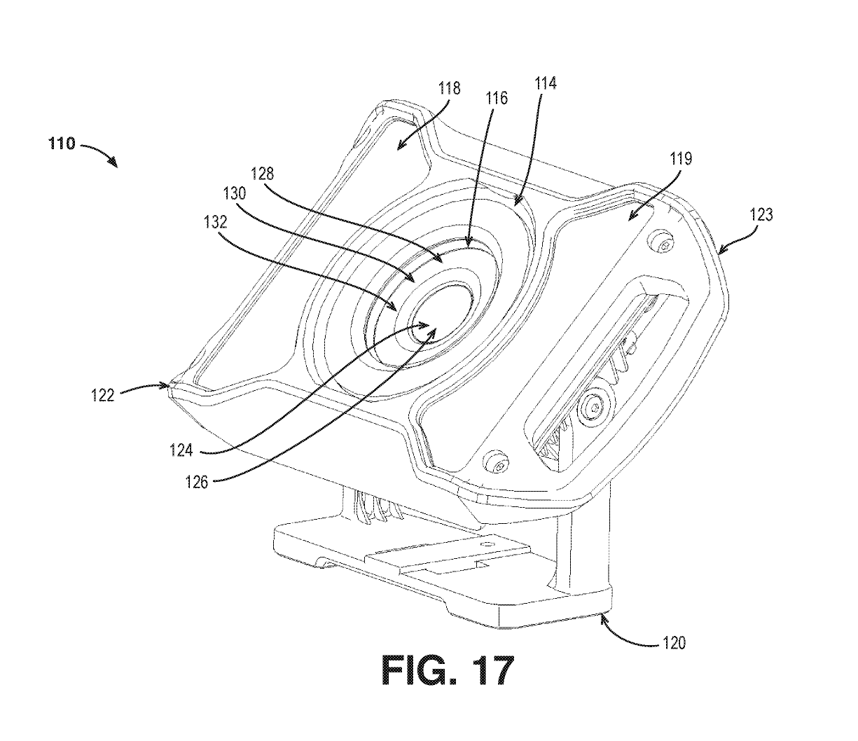

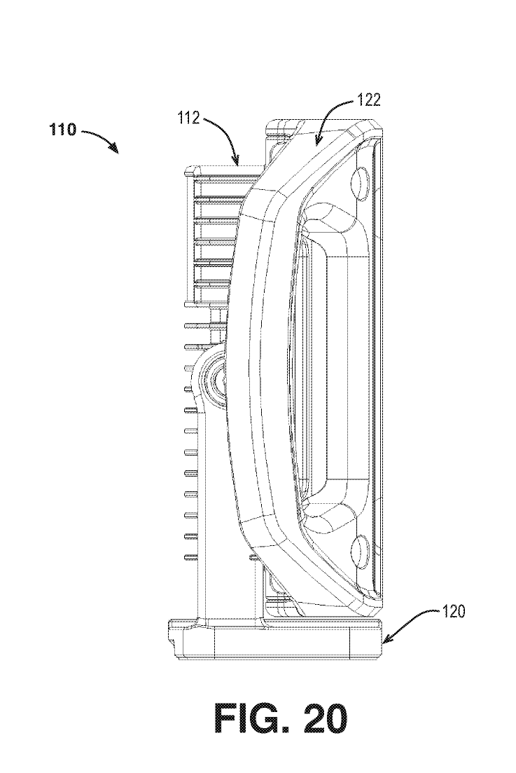

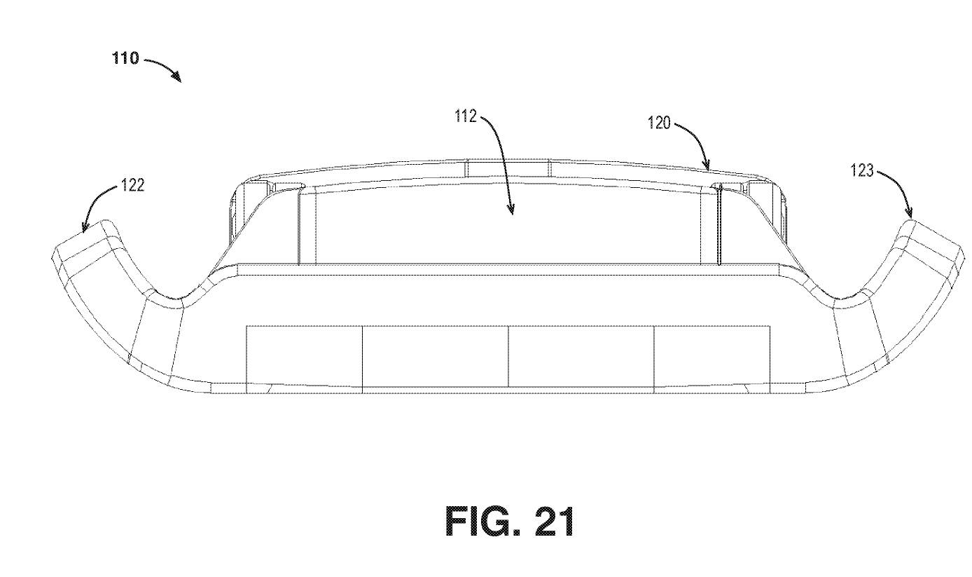

Referring now to FIGS. 12-21, there is illustrated a second example audio light 110 in accordance with the teachings of the present disclosure. The example audio light 110 comprises a housing 112, a lighting unit 116 received in an opening 114 of the housing 112, a pair of speakers 118, 119 disposed in the housing 112, and a bracket 120 connected to the housing 112.

The example audio light 110 may be configured for both indoor and outdoor use. Thus, the housing 112 may be formed to provide the audio light 110 with impact resistance, water resistance, and/or dust resistance. In the example shown in FIGS. 12-21, the housing 112 is formed with high quality aluminum. However, as will be appreciated by one of ordinary skill in the art, the example housing 112 may be formed with any suitable material, such as for instance, plastic, carbon fiber, etc. The housing 112 may also be provided with a pair of handle bars 122, 123.

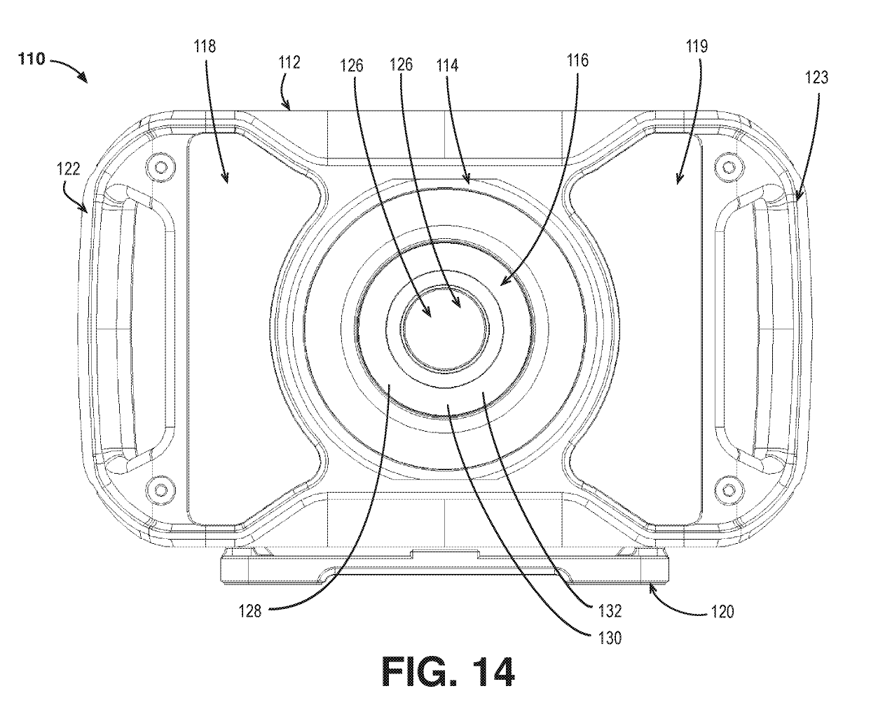

Referring now to FIGS. 14-15 and 17, the lighting unit 116 includes a light source 124. The light source 124 may comprise one or more LEDs, incandescent bulbs, fluorescent bulbs, halogen bulbs, or the like. In the illustrated embodiment, the light source 124 comprises a high-efficiency, high color rendition index chip-on-board LED. The lighting unit 116 may also include a lens 126 positioned over the light source 124. The lighting unit 116 may further include a reflecting unit 128, so that the audio light 110 can be easily found in the dark. The reflecting unit 128 comprises a reflector 130 and a fluorescer 132. The lighting unit 116 may also include a dimmer (not shown) for adjusting the brightness of the light source 124.

The audio light 110 may additionally include a controller (not shown) disposed in the housing 112. The controller is operably connected to a transceiver (not shown). The controller is configured to receive control signals wirelessly at its transceiver from an external wireless device (not shown), such as a cellular phone, laptop computer, tablet computer, or the like, using radio frequency (RF) transmission. This can be a dedicated RF link, or it can be a wireless network conforming to the international standards such as the Wi-Fi, Bluetooth, or Ultra-Wide-Band (UWB) standards. Other wireless technologies not mentioned above, such as ultra-sound or optical, may also be applicable in this case. Control signals may include, for example, signals for turning on and off or dimming the light source 124, signals for controlling the volume of the pair of speakers 118, 119, signals for playing music through the pair of speakers 118, 119, and the like.

In one embodiment of the present disclosure, the controller is operably connected to the lighting unit 116 and the pair of speakers 118, 119, such that the controller can perform control of the lighting unit 116 and the pair of speakers 118, 119 in response to a control signal received from the external wireless device. For instance, if the controller receives a signal to dim the light source 124, the controller will cause the light source 124 to dim. In another embodiment of the present disclosure, the controller is operably connected to a light source driver (not shown) and a speaker driver (not shown). The light source driver and the speaker driver are configured to perform control of the light source 124 and the pair of speakers 118, 119, respectively. When the controller receives a control signal from the external wireless device, the controller forwards the control signal to the light source driver or the speaker driver. For instance, if the controller receives a signal to dim the light source 124, the controller will forward the signal to the light source driver, and the light source driver will cause the light source 124 to dim.

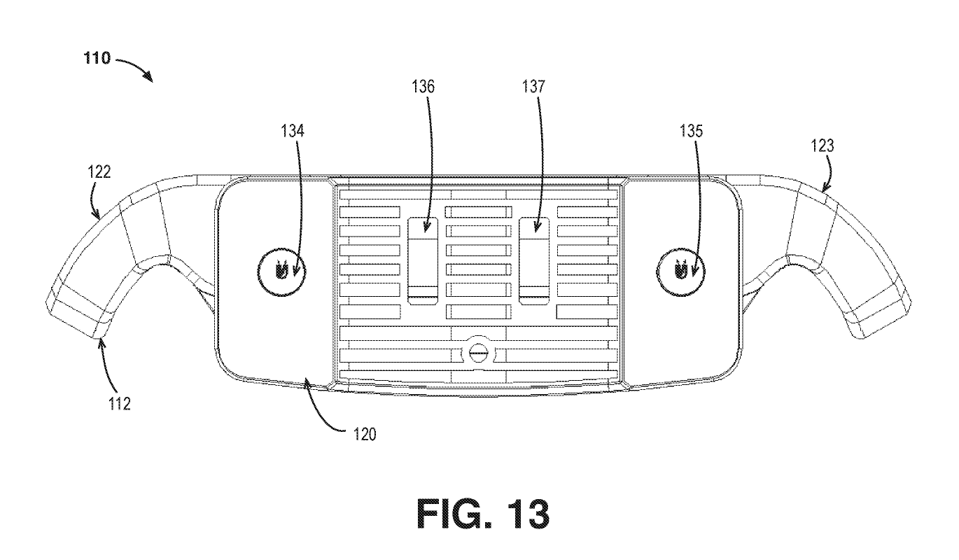

In this disclosure, the bracket 120 of the audio light 110 is pivotally connected to the housing 112 so that the housing 112 may rotate with respect to the bracket 120. It will be appreciated, however, that the bracket 120 need not be pivotally connected to the housing 112, but rather may be connected to the housing 112 in any suitable manner. As shown in FIG. 13, the bracket 120 may include a pair of magnets 134, 135, so as to allow the bracket 120 to be magnetically coupled to a metal surface, such as the hood of a car. It will be understood that the size, number, and/or location of the pair of magnets 134, 135 may vary as necessary or desired. The bracket 120 may also include a plurality of holes 136, 137 for connecting the bracket 120 to a stand or support surface (not shown). It will be understood that the size, number, and/or location of the holes 136, 137 may vary as necessary or desired.

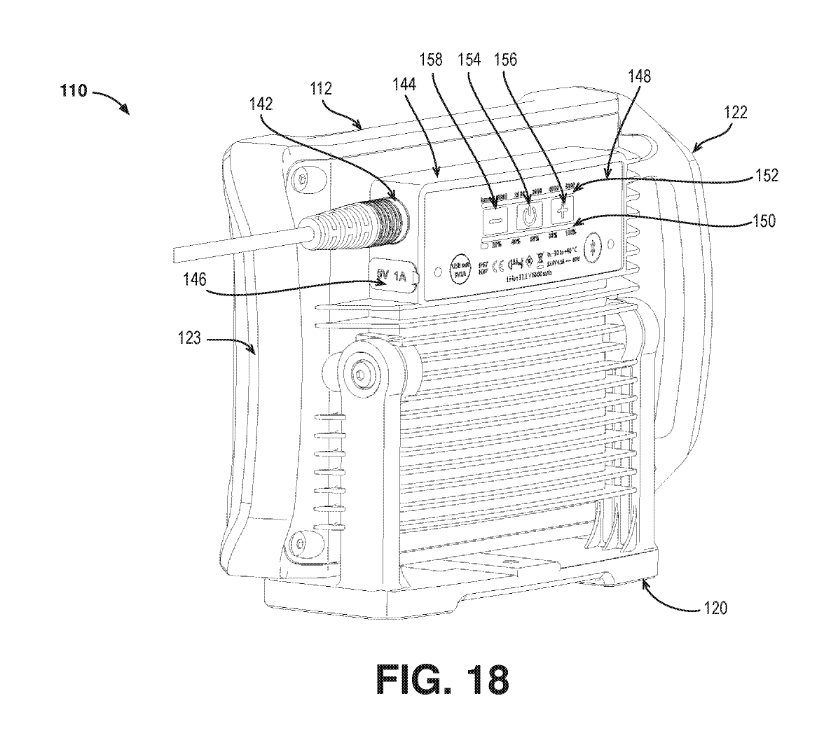

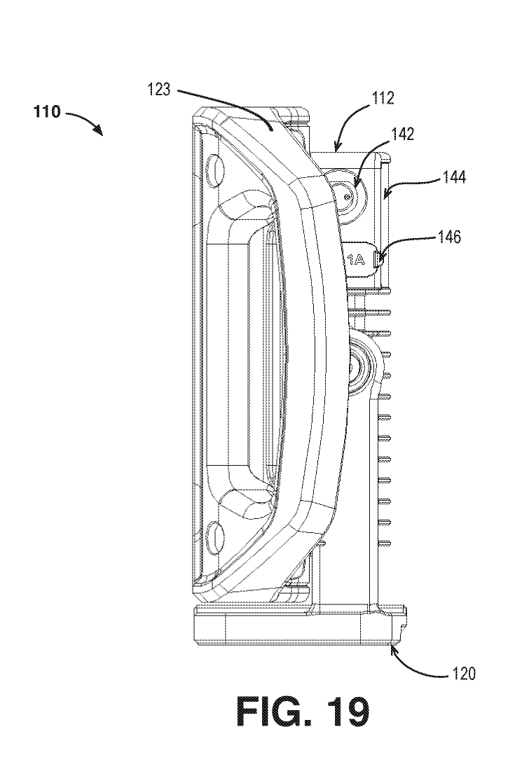

The audio light 110 may also include an internal power supply (not shown), such as a rechargeable lithium-ion battery, so that the audio light 110 may be operated even when disconnected from an external power source (not shown), such as a standard electrical outlet. As shown in FIGS. 18 and 19, to facilitate charging of the internal power supply, an external charging socket 142 may be provided on an exterior surface 144 of the housing 112. It will be understood that the location of the external charging socket 142 may vary as necessary or desired. The external charging socket 142 is configured to receive a first end of a first cable (not shown). The first cable may be any type of cable suitable for transferring an electrical signal, such as a Universal Serial Bus (USB) cable or the like. The first cable may be selectively connected to the external power source at a second end of the first cable.

In one mode of operation, when the first end of the first cable is connected to the external charging socket 142, and the second end of the first cable is connected to the external power source, the internal power supply is charged by the external power source. When the internal power supply is charged, the first cable may be disconnected from the external charging socket 142, and the audio light 110 may be operated without being connected to the external power source by drawing power from the internal power supply. In an alternate mode of operation, when the first end of the first cable is connected to the external charging socket 142 and the second end of the first cable is connected to the external power source, the audio light 110 is powered directly by the external power source.

As further shown in FIGS. 18 and 19, the audio light 110 may also include a power bank 146 provided on the exterior surface 144 of the housing 112. It will be understood that the location of the power bank 146 may vary as necessary or desired. The power bank 146 is configured to receive a first end of a second cable (not shown). The second cable may be any type of cable suitable for transferring an electrical signal, such as a Universal Serial Bus (USB) cable or the like. The second cable may be connected to an external device (not shown) at a second end of the second cable, such that when the first end of the second cable is connected to the power bank 146 and the second end of the second cable is connected to the external device, an electrical signal may travel from the audio light 110 to the external device. For instance, the electrical signal may be used to charge a cell phone.

As shown in FIGS. 12, 16, and 18, the audio light 110 may additionally include an interactive display 148 positioned on the exterior surface 144 of the housing 112. It will be understood that the location of the interactive display 148 may vary as necessary or desired. The interactive display 148 may include, for example, a battery capacity indicator 150 for indicating the charge left in the internal power supply, a luminous flux dimmer 152 for indicating the brightness of the light source 124, and a power button 154 for turning on and turning off the audio light 110. The interactive display 148 may also include a plus button 156 for increasing the brightness of the light source 124 and/or increasing the volume of the pair of speakers 118, 119. The interactive display 148 may further include a minus button 158 for decreasing the brightness of the light source 124 and/or decreasing the volume of the pair of speakers 118, 119. It will be understood that the components, features, and layout of the interactive display 148 are not limited to that shown in the illustrated example, but rather may vary as necessary or desired.

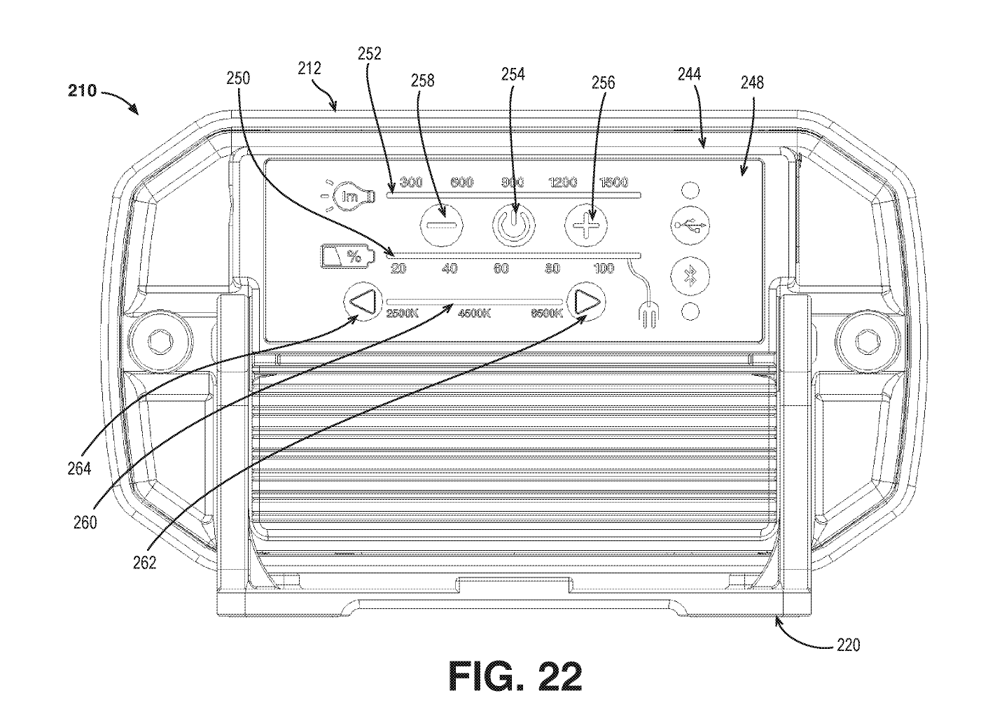

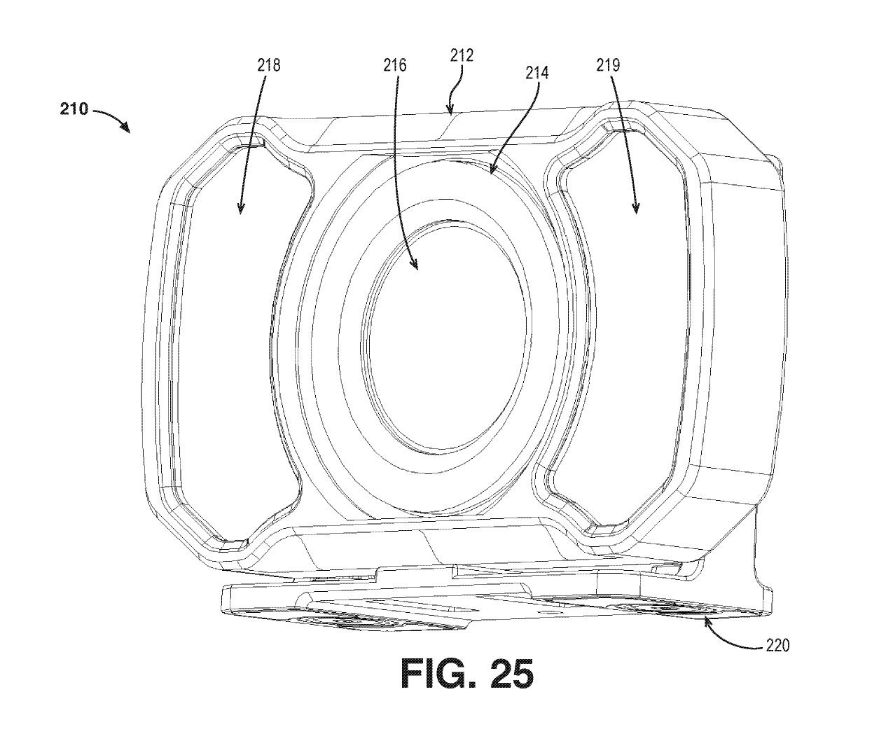

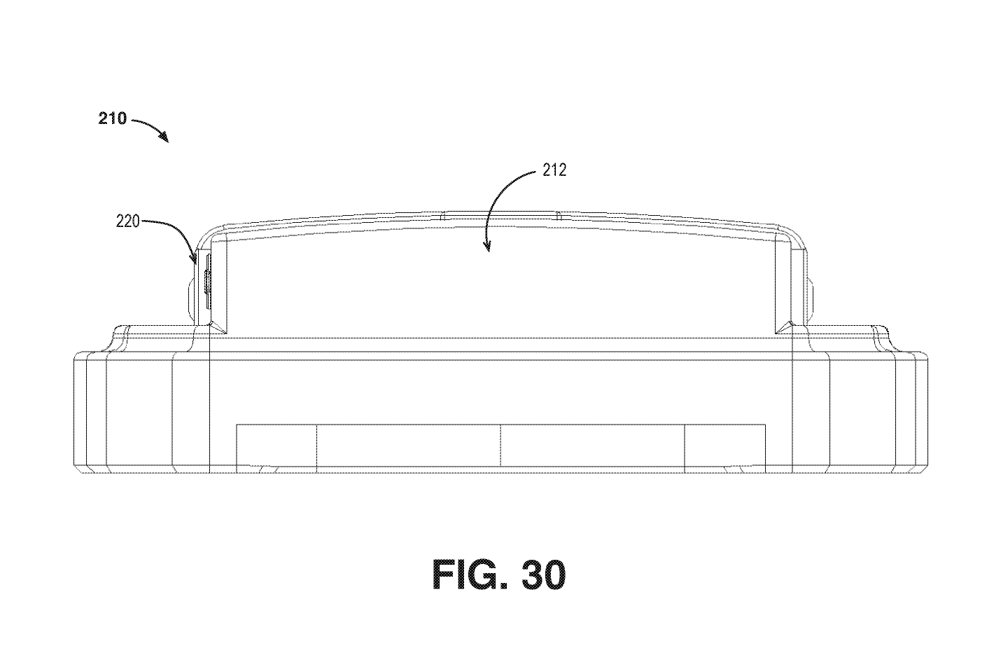

Referring now to FIGS. 22-30, there is illustrated a third example audio light 210 in accordance with the teachings of the present disclosure. The example audio light 210 comprises a housing 212, a lighting unit 216 received in an opening 214 of the housing 212, a pair of speakers 218, 219 disposed in the housing 212, and a bracket 220 connected to the housing 212.

The example audio light 210 may be configured for both indoor and outdoor use. Thus, the housing 212 may be formed to provide the audio light 210 with impact resistance, water resistance, and/or dust resistance. In the example shown in FIGS. 22-30, the housing 212 is formed with high quality aluminum. However, as will be appreciated by one of ordinary skill in the art, the example housing 212 may be formed with any suitable material, such as for instance, plastic, carbon fiber, etc.

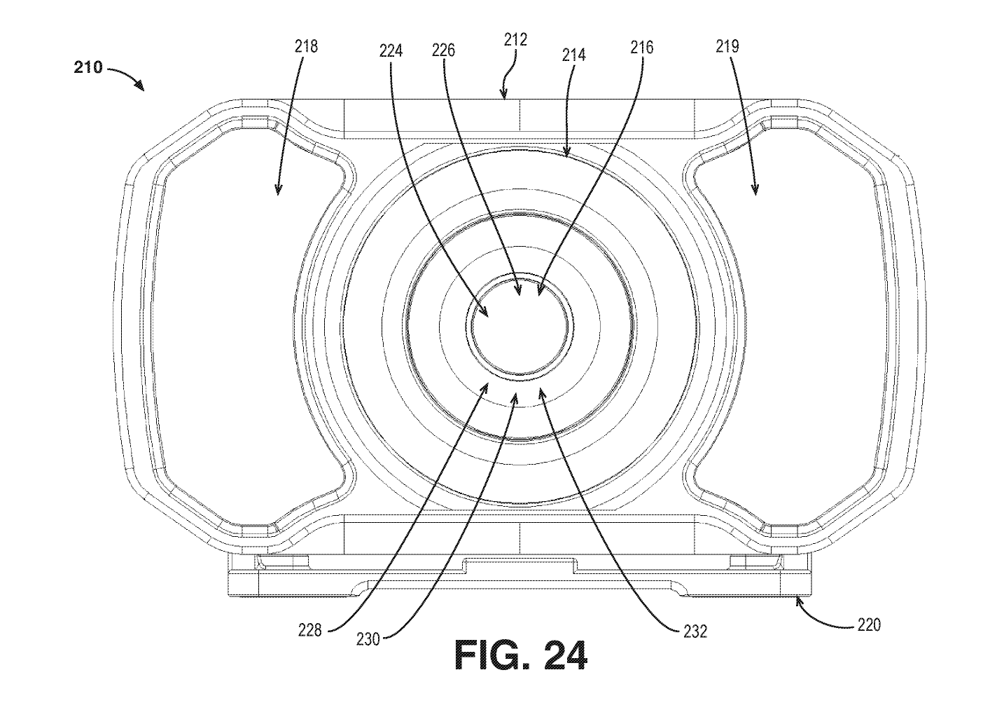

Referring now to FIGS. 24-26, the lighting unit 216 includes a light source 224. The light source 224 may comprise one or more LEDs, incandescent bulbs, fluorescent bulbs, halogen bulbs, or the like. In the illustrated embodiment, the light source 224 comprises a high-efficiency, high color rendition index chip-on-board LED. The lighting unit 216 may also include a lens 226 positioned over the light source 224. The lighting unit 216 may further include a reflecting unit 228, so that the audio light 210 can be easily found in the dark. The reflecting unit 228 comprises a reflector 230 and a fluorescer 232. The lighting unit 216 may also include a dimmer (not shown) for adjusting the brightness of the light source 224.

The audio light 210 may additionally include a controller (not shown) disposed in the housing 212. The controller is operably connected to a transceiver (not shown). The controller is configured to receive control signals wirelessly at its transceiver from an external wireless device (not shown), such as a cellular phone, laptop computer, tablet computer, or the like, using radio frequency (RF) transmission. This can be a dedicated RF link, or it can be a wireless network conforming to the international standards such as the Wi-Fi, Bluetooth, or Ultra-Wide-Band (UWB) standards. Other wireless technologies not mentioned above, such as ultra-sound or optical, may also be applicable in this case. Control signals may include, for example, signals for turning on and off or dimming the light source 224, signals for controlling the volume of the pair of speakers 218, 219, signals for playing music through the pair of speakers 218, 219, and the like.

In one embodiment of the present disclosure, the controller is operably connected to the lighting unit 216 and the pair of speakers 218, 219, such that the controller can perform control of the lighting unit 216 and the pair of speakers 218, 219 in response to a control signal received from the external wireless device. For instance, if the controller receives a signal to dim the light source 224, the controller will cause the light source 224 to dim. In another embodiment of the present disclosure, the controller is operably connected to a light source driver (not shown) and a speaker driver (not shown). The light source driver and the speaker driver are configured to perform control of the light source 224 and the pair of speakers 218, 219, respectively. When the controller receives a control signal from the external wireless device, the controller forwards the control signal to the light source driver or the speaker driver. For instance, if the controller receives a signal to dim the light source 224, the controller will forward the signal to the light source driver, and the light source driver will cause the light source 224 to dim.

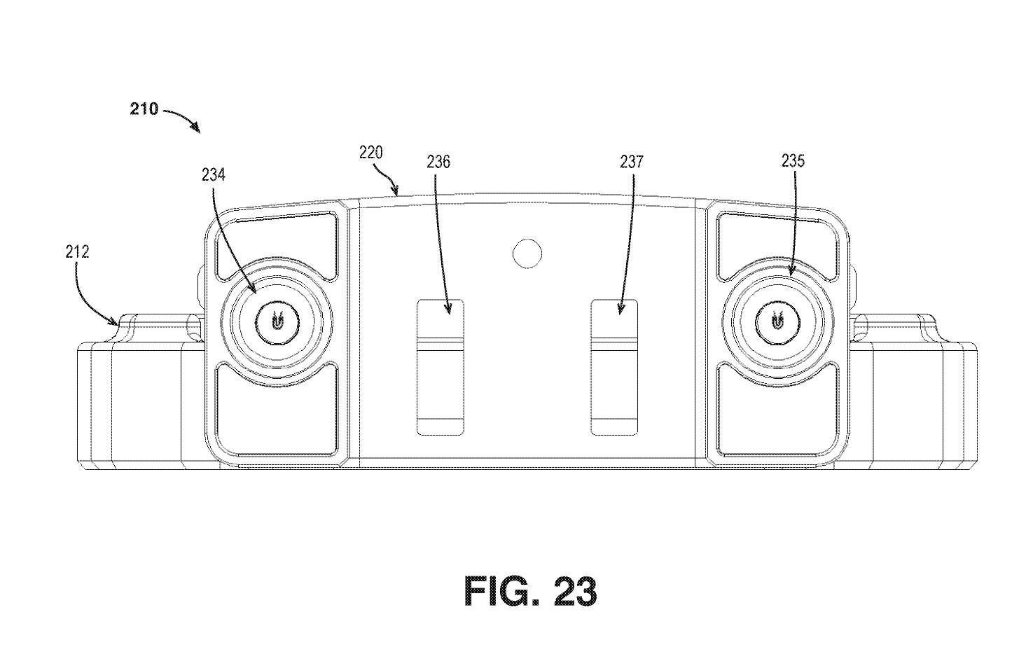

In this disclosure, the bracket 220 of the audio light 210 is pivotally connected to the housing 212 so that the housing 212 may rotate with respect to the bracket 220. It will be appreciated, however, that the bracket 220 need not be pivotally connected to the housing 212, but rather may be connected to the housing 212 in any suitable manner. As shown in FIG. 23, the bracket 220 may include a pair of magnets 234, 235, so as to allow the bracket 220 to be magnetically coupled to a metal surface, such as the hood of a car. It will be understood that the size, number, and/or location of the pair of magnets 234, 235 may vary as necessary or desired. The bracket 220 may also include a plurality of holes 236, 237 for connecting the bracket 220 to a stand or support surface (not shown). It will be understood that the size, number, and/or location of the holes 236, 237 may vary as necessary or desired.

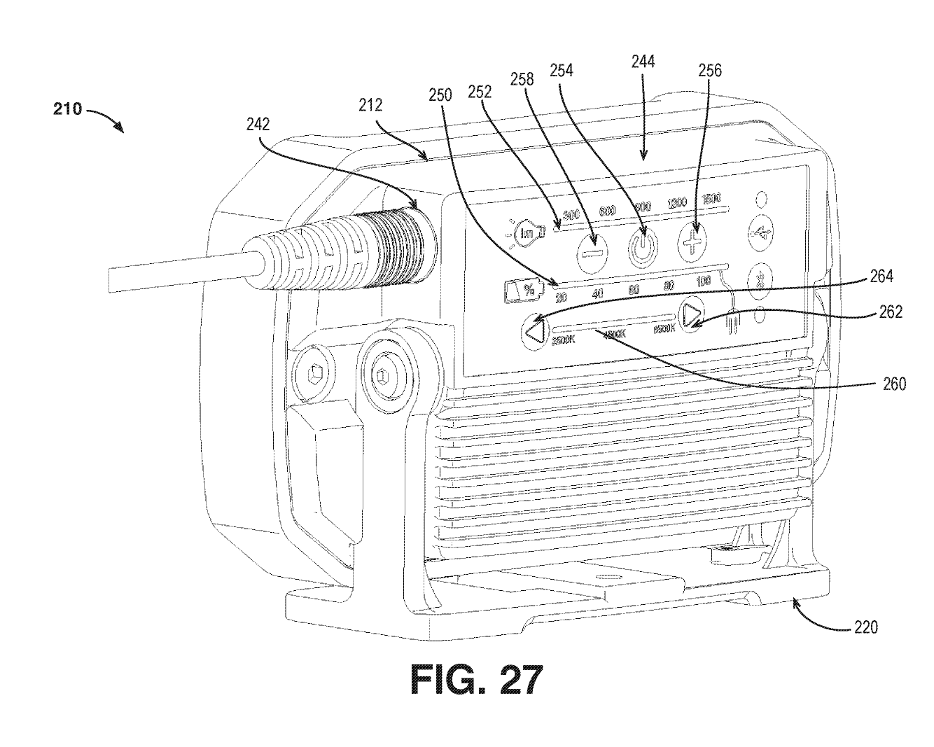

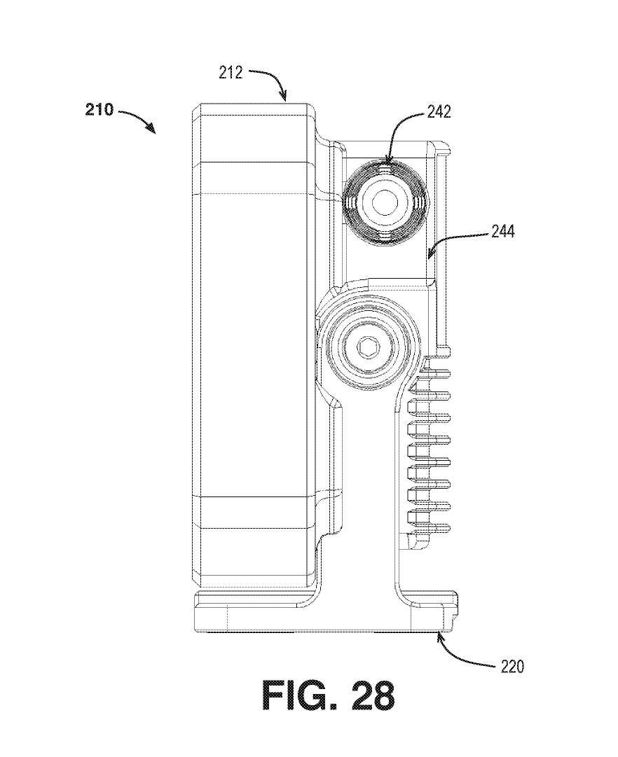

The audio light 210 may also include an internal power supply (not shown), such as a rechargeable lithium-ion battery, so that the audio light 210 may be operated even when disconnected from an external power source (not shown), such as a standard electrical outlet. As shown in FIGS. 27 and 28, to facilitate charging of the internal power supply, an external charging socket 242 may be provided on an exterior surface 244 of the housing 212. It will be understood that the location of the external charging socket 242 may vary as necessary or desired. The external charging socket 242 is configured to receive a first end of a first cable (not shown). The first cable may be any type of cable suitable for transferring an electrical signal, such as a Universal Serial Bus (USB) cable or the like. The first cable may be selectively connected to the external power source at a second end of the first cable.

In one mode of operation, when the first end of the first cable is connected to the external charging socket 242, and the second end of the first cable is connected to the external power source, the internal power supply is charged by the external power source. When the internal power supply is charged, the first cable may be disconnected from the external charging socket 242, and the audio light 210 may be operated without being connected to the external power source by drawing power from the internal power supply. In an alternate mode of operation, when the first end of the first cable is connected to the external charging socket 242 and the second end of the first cable is connected to the external power source, the audio light 210 is powered directly by the external power source.

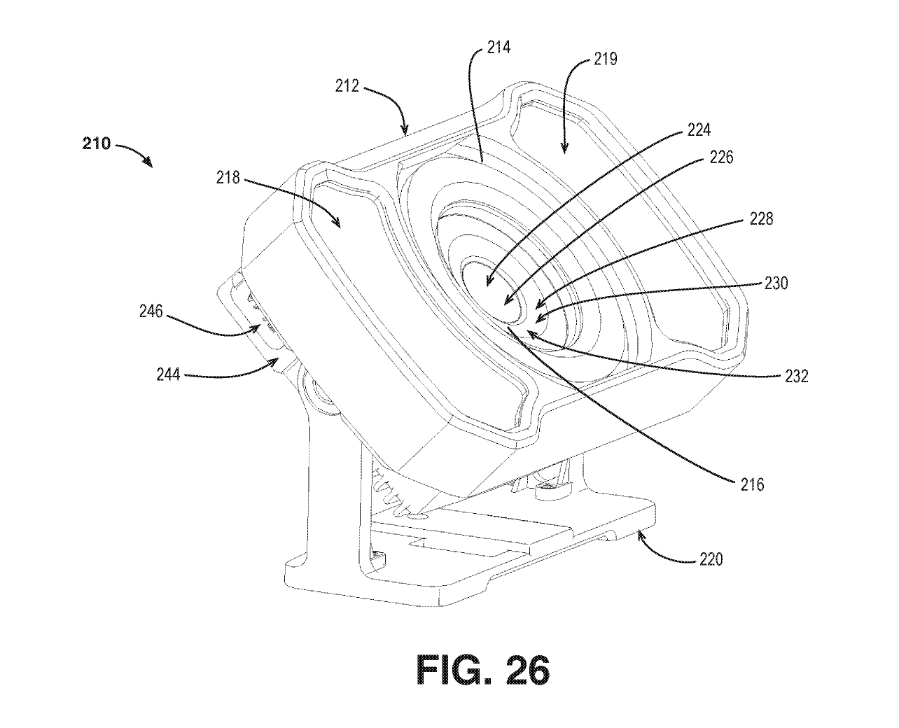

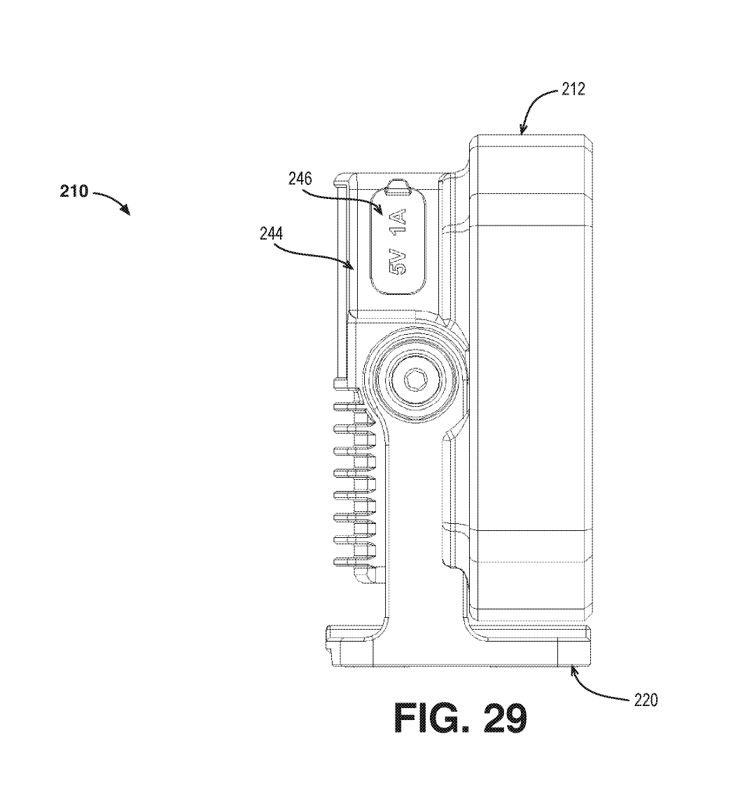

As shown in FIGS. 26 and 29, the audio light 210 may also include a power bank 246 provided on the exterior surface 244 of the housing 212. It will be understood that the location of the power bank 246 may vary as necessary or desired. The power bank 246 is configured to receive a first end of a second cable (not shown). The second cable may be any type of cable suitable for transferring an electrical signal, such as a Universal Serial Bus (USB) cable or the like. The second cable may be connected to an external device (not shown) at a second end of the second cable, such that when the first end of the second cable is connected to the power bank 246 and the second end of the second cable is connected to the external device, an electrical signal may travel from the audio light 210 to the external device. For instance, the electrical signal may be used to charge a cell phone.

As shown in FIGS. 22 and 27, the audio light 210 may additionally include an interactive display 248 positioned on the exterior surface 244 of the housing 212. It will be understood that the location of the interactive display 248 may vary as necessary or desired. The interactive display 248 may include, for example, a battery capacity indicator 250 for indicating the charge left in the internal power supply, a luminous flux dimmer 252 for indicating the brightness of the light source 224, and a power button 254 for turning on and turning off the audio light 210. The interactive display 248 may also include a plus button 256 for increasing the brightness of the light source 224 and/or increasing the volume of the pair of speakers 218, 219. The interactive display 248 may further include a minus button 258 for decreasing the brightness of the light source 224 and/or decreasing the volume of the pair of speakers 218, 219. The interactive display 248 may additionally include a color temperature indicator 260 for indicating the color temperature of the light source 224, as well as a pair of buttons 262, 264 for increasing and decreasing the color temperature of the light source 224, respectively. It will be understood that the components, features, and layout of the interactive display 248 are not limited to that shown in the illustrated example, but rather may vary as necessary or desired.

Although certain example methods and apparatus have been described herein, the scope of coverage of this patent is not limited thereto. On the contrary, this patent covers all methods, apparatus, and articles of manufacture fairly falling within the scope of the appended claims either literally or under the doctrine of equivalents.

What is claimed is:

1. An audio light comprising:
a housing;
a light source affixed to a surface of the housing and operable to emit light;
one or more speakers disposed in the housing and operable to emit sound;
a bracket coupled to the housing; and
a power source operable to power the light source and the one or more speakers.

2. The audio light of claim 1, wherein the light source is one or more LEDs.

3. The audio light of claim 1, wherein the bracket is pivotally coupled to the housing.

4. The audio light of claim 1, further comprising at least one magnet affixed to a surface of the bracket.

5. The audio light of claim 1, further comprising a power button positioned on a surface of the bracket and operable to turn on and turn off the light source and the one or more speakers.

6. The audio light of claim 1, further comprising a reflecting unit affixed to the surface of the housing, the reflecting unit comprising a reflector and a fluorescer.

7. The audio light of claim 1, further comprising a wireless transceiver, wherein the wireless transceiver is operable to receive radio frequency signals from an external wireless device over a wireless network.

8. The audio light of claim 1, wherein the power source comprises a battery.

9. The audio light of claim 8, wherein the battery is rechargeable by an external A/C or D/C power source.

10. An audio light comprising:
a housing;
a light source affixed to a surface of the housing and operable to emit light;
one or more speakers disposed in the housing and operable to emit sound; and
a power source operable to power the light source and the one or more speakers.

11. The audio light of claim 10, wherein the light source is one or more LEDs.

12. The audio light of claim 10, further comprising a bracket coupled to the housing.

13. The audio light of claim 12, wherein the bracket is pivotally coupled to the housing.

14. The audio light of claim 12, further comprising at least one magnet affixed to a surface of the bracket.

15. The audio light of claim 10, further comprising a reflecting unit affixed to the surface of the housing, the reflecting unit comprising a reflector and a fluorescer.

16. The audio light of claim 10, further comprising a wireless transceiver, wherein the wireless transceiver is operable to receive radio frequency signals from an external wireless device over a wireless network.

17. The audio light of claim 10, wherein the power source comprises a battery or an adaptor connected to an external A/C or D/C power source.

18. The audio light of claim 17, wherein the battery is rechargeable by the external A/C or D/C power source.

19. The audio light of claim 10, further comprising a pair of handles formed in the housing.

20. The audio light of claim 10, further comprising a display positioned on the surface of the housing.

21. The audio light of claim 20, wherein the display includes at least one of a luminous flux dimmer for indicating a brightness of the light source, a power button for turning on and turning off the light source and the one or more speakers, a brightness button for increasing or decreasing the brightness of the light source, and a volume button for increasing or decreasing a volume of the one or more speakers.
